(19) United States
(12) Patent Application Publication
(10) Pub. No.: US 2015/0213568 A1
(43) Pub. Date: Jul. 30, 2015

(54) LOCATION AWARE SELECTION OF ELECTRONIC SIGNATURES

(71) Applicant: Adobe Systems Incorporated, San Jose, CA (US)

(72) Inventors: Benjamin David Follis, Redwood City, CA (US); Marc Kaufman, Woodside, CA (US)

(73) Assignee: Adobe Systems Incorporated, San Jose, CA (US)

(21) Appl. No.: 14/167,751

(22) Filed: Jan. 29, 2014

(51) Int. Cl. G06Q 50/18; H04L 29/08

(52) U.S. Cl. CPC G06Q 50/18; H04L 67/18

(57) ABSTRACT

Techniques for generating a document according to location-specific and other requirements may be provided. For example, an electronic signature service may be executed by a computing device to provide a service for generating a document that meets various location-specific and other requirements. The documents may be associated with number of users. The electronic signature service may determine locations of the users and may determine applicable requirements based on the users and the locations. Further, the electronic signature service may modify the document and/or a workflow associated with the document to meet the applicable requirements.

### TECHNICAL FIELD

This disclosure relates generally to computer-implemented methods and systems for generating documents according to location-specific and other requirements.

### BACKGROUND

Users may operate computers and computing services, such as an electronic signature service, to exchange and electronically sign contracts. In many situations, the users may be located in multiple jurisdictions that have different requirements around what constitutes binding signatures in a contract. For example, a user may be located in in the United States of America and another user may be located in the European Union. In comparison, the laws of the United States of America may accept any form of an electronic signature, whereas the laws of the European Union may require a digital signature issued by a European agency. As such, for the electronic signatures of the users to be binding in both jurisdictions, the contract needs to be carefully drafted to include proper electronic signature fields that meet the different jurisdictional requirements.

Although the computing services allow the users to exchange and electronically sign the contract, the computing services do not automatically update the contract to meet the different jurisdictional requirements. Instead, it is necessary for the users to know the requirements and to upload to the computing service a contract that meets these requirements. However, it may be incumbent on the users to acquire such knowledge. Further, even if known, the users may need to invest substantial time and resources to draft the contract.

### SUMMARY

In certain embodiments, a computing service executed by a computing device automatically modifies a contract to meet various location-based requirements, including jurisdictional requirements. For example, the computing service may determine a location of a user requested to electronically sign a contract. Based on this location, the computing service may determine requirements specific to that location and applicable to the contract and may determine if the contract meets the requirements. If not, the computing service may automatically modify the contract to meet the requirements. Further, the computing service may present the contract, as modified, to the user for an electronic signature. In this way and without necessitating the user to know the requirements, the computing service may ensure that the presented contract meets the requirements specific to the user's location.

These illustrative features are mentioned not to limit or define the disclosure, but to provide examples to aid understanding thereof. These and additional features may be implemented independently in various embodiments or may be combined in yet other embodiments, further details of which can be seen with reference to the following description and illustrations. Advantages offered by one or more of the various embodiments may be further understood by examining the specification or by practicing one or more of the various embodiments.

### BRIEF DESCRIPTION OF THE FIGURES

Embodiments of techniques according to the present invention are described in detail below with reference to the following drawings:

FIG. 1 illustrates an example computing environment for generating a document that meets various requirements, according to embodiments of the present invention;

FIG. 2 illustrates an example document, according to embodiments of the present invention;

FIG. 3 illustrates example workflow associated with a document, according to embodiments of the present invention;

FIG. 4 illustrates an example computing architecture of a service for generating a document that meets various requirements, according to embodiments of the present invention;

FIG. 5 illustrates another example flow for generating a document that meets various requirements, according to embodiments of the present invention;

FIG. 6 illustrates another example flow for generating a document that meets various requirements when locations are initially known, according to embodiments of the present invention;

FIG. 7 illustrates another example flow for generating a document that meets various requirements when at least one location is initially unknown, according to embodiments of the present invention;

FIG. 8 illustrates an example flow for determining a location of a user, according to embodiments of the present invention; and

FIG. 9 illustrates an example computing architecture in which various embodiments can be implemented.

### DETAILED DESCRIPTION

Generally, the embodiments described herein are directed to, among other things, allowing users to generate documents according to location-specific and other requirements. For example, a computing service, such as an electronic signature service, may be implemented to modify a contract to automatically meet various jurisdictional requirements. Specifically, users located in various jurisdictions may desire to enter in a contract binding in the jurisdictions. To do so, the users can turn to the computing service for generating a contract that meets corresponding jurisdictional requirements. The computing service may receive the contract from one of the users or may assist the users in creating the contract. Further, the computing service may access pre-stored jurisdictional requirements to determine the requirements that apply to the jurisdictions where the users are located. To ensure compliance with the applicable requirements, the computing service may compare the contract to the requirements and may modify the contract, as necessary. Once the applicable requirements are met, the computing service may present the compliant contract to the users. In turn, the users may electronically sign the contract.

As such, the computing service may use the locations of the users to determine which jurisdictions the contract should be recognized in and may automatically modify the contract to meet the corresponding jurisdictional requirements. In this way, the users need not know the jurisdictional requirements and need not upload an already compliant contract to the computing service. Instead, the effort of the users may be minimized because the computing service may automatically ensure that the contract meets the jurisdictional requirements.

As used herein, a “computing service” refers to a service provided by a workflow or process flow executed on a computing device for providing various services to users. An example of a computing service is an electronic signature service, such as EchoSign® from Adobe Systems, Incorporated, configurable to facilitate the exchange of electronic documents between users and applications of electronic signatures to the electronic documents. The computing service may be implemented, in one embodiment, by software programs executed on one or more computing systems to carry out numerous workflow tasks. The computing service may also be implemented using computing hardware and/or firmware.

As used herein, an “electronic document” refers to a document that has an electronic format and that can be exchanged and signed by users. In an example, an electronic document can reflect or relate to an agreement between users such as a contract, an offer, a memorandum of understanding, a letter of intent, etc. Other examples of electronic documents include, without limitation, policy documents, minutes, notes, memoranda, cards, drawings, reports, lists, legal opinions, letters, etc. In general, the invention is not limited to any particular type of electronic document and is applicable to any type of electronic document that may require at least one electronic signature.

As used herein, a “workflow” refers to a series of actions that should or may be required to be performed in association with an electronic signature of an electronic document. In an example, a user may define a workflow that can be executed by an electronic signature service to facilitate an exchange of an electronic document between users and applications of electronic signatures to the electronic document. In this example, the user may identify the users, specify an order in which the users must apply their electronic signatures, indicate whether the electronic signature service can modify the electronic document or the workflow, request that a copy of the electronic document be stored at a certain server, and specify other type of information pertinent to the execution and handling of the electronic document.

As used herein, an “electronic signature” of a user refers to information that represents an assent of the user to content of an electronic document for which the electronic signature is provided. For example, an electronic signature may be a digital signature, electronic data representing a click-through response, a typed signature, a computer generated signature for a user, a scanned signature for a user, a faxed signature of a user, or a voice recording, a finger swipe, a photo, a video, or other biometric reading of the user.

As used herein, a “location-based requirement” refers to a requirement that may be specific to a location. In an example, jurisdictions, geographical borders, physical boundaries, or virtual boundaries may define the location. The requirement may be legal and may render a compliant electronic document legally binding in the location. Alternatively, the requirement may be non-legal, such as a procedure or a policy of a company that may vary with the location of the company.

As explained herein above, a computing service, such as an electronic signature service may be implemented to provide various services to users. The electronic signature service may allow a first user at a first location to specify content of a document, to identify a second user at a second location that should to agree to the content, and identify any other location where the document may be relevant. The electronic signature service may also maintain, for each location, or have access to requirements applicable to the document. In response to the input of the first user, the electronic signature service may determine the various relevant locations (e.g., the first location, the second location, and/or any other identified location), may generate a rule set that unifies the requirements associated with the various locations, and may apply the rule set to generate or update the document such that the document may meet the requirements. Once the document satisfies the requirements, the electronic signature service may present the document to and receive signatures from the first and second users.

To illustrate, the first user may be located in the United States of America and may be a sender of a contract, whereas the second user may be located in the European Union and may be a signer of the contract. The sender may identify that the contract should be also legally binding in Japan. To be legally binding in the United States of America, the contract may need to include a certain contractual statement (e.g., a positive assent statement). In comparison, to be legally binding in the European Union, the contract may need to include a certain signature field (e.g., a digital signature that uses a certificate issued by a national agency). Similarly, to be legally binding in Japan, the contract may need to meet a certain workflow (e.g., a series of actions that may include, for instance, storing a copy of the contract at a local agency in Japan). The electronic signature service may maintain or have access to a database that stores these various location-based requirements.

The described legal requirements herein are for illustrative purposes and are used to exemplify that different jurisdictions can have different legal and other requirements applicable to a contract and/or a workflow, such as to the associated form, structure, content, and signatures of the contract and/or workflow.

In response to the sender specifying the terms of the contract, the electronic signature service may determine that the contract should be legally binding in three jurisdictions: the United States of America, the European Union, and Japan. As such, the electronic signature service may modify the contract and/or the workflow to meet the requirements of these three jurisdictions. For example, the electronic signature service may add the contractual statement to the contract and update a signature field to accept a digital signature. Subsequently, the electronic signature service may present the contract to the sender and signer and may receive an electronic signature from the sender and a digital signature from the signer. Also, the electronic signature service may execute the required flow including, for example, sending a copy of the signed contract to the Japanese local agency.

As such, the electronic signature service may minimize the effort of the sender and/or signer to enter into a legally binding contract. For example, the sender and/or signer need not be aware of the various location-based and other requirements and need not manually modify the contract to meet these requirements. Instead, the electronic signature service may automatically generate or modify the contract by determining the locations and using the corresponding location-based requirements. These and other aspects of the present disclosure are further described herein below.

In the interest of clarity of explanation, the various embodiments herein below describe users generating a contract. However, the present disclosure is not limited to contractual documents. Instead, the embodiments similarly apply to any other types of electronic documents that may require at least one electronic signature, such as (but not limited to) offers, memorandums of understanding, letters of intent, policy documents, minutes, notes, memoranda, cards, drawings, reports, lists, legal opinions, letters, etc.

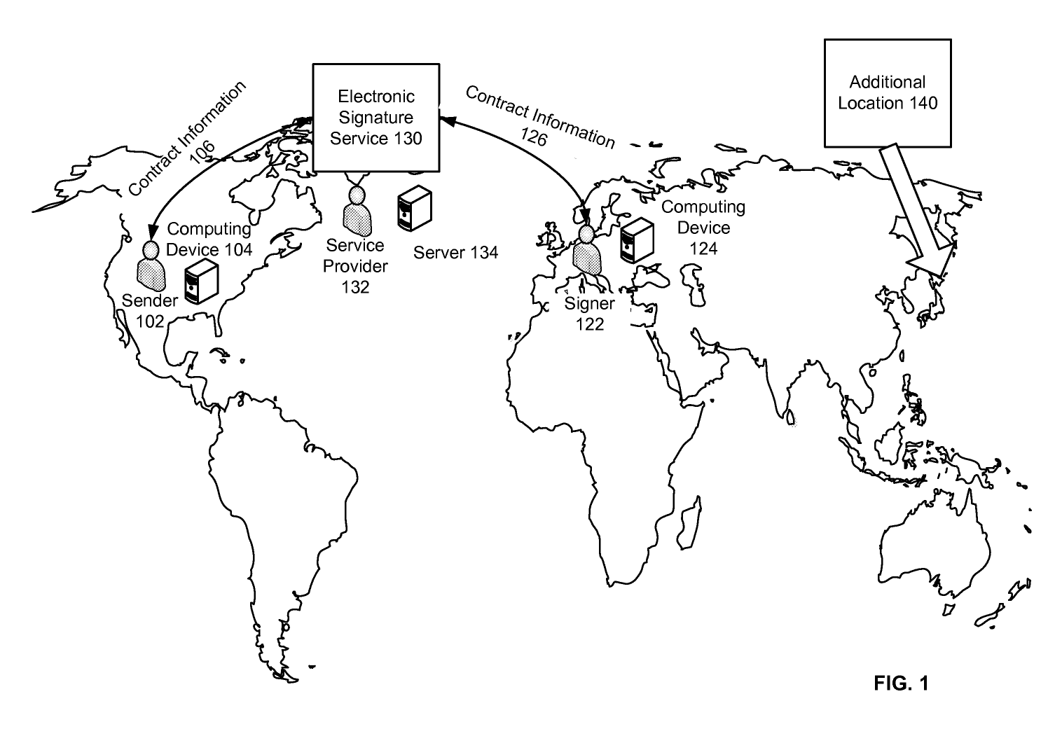

FIG. 1 illustrates an example computing environment for generating a contract according to legal and/or other requirements, such as requirements specific to one or more location. More particularly, a sender 102 and a signer 122 may interact with the computing environment to enter into a contract that may be binding at the locations of the sender 102, the signer 122, and additional location(s) 140. To do so, the sender 102 and the signer 122 may operate computing devices 104 and 124, respectively, to connect to a server 134 over a network. A service provider 132 may implement on the server 134 an electronic signature service 130 for facilitating the generation of the contract.

In an example, the computing devices 104 and 124 may be any type of computing devices configured to communicate with another computing device over a network to access information. A mobile phone, a smart phone, a personal digital assistant (PDA), a tablet, a laptop, a personal computer, a desktop computer and other computing devices are examples of the computing devices 104 and 124. Similarly, the server 134 may include a computing device or may include a number of computing devices clustered as a computing system configured to host one or more network-based resources such as the electronic signature service 130. A datacenter and a server farm are examples of such computing system. The computing devices 104 and 124 and the server 134 may be connected by any type of communication network that may include, for example, any one or a combination of many different types of networks, such as cable networks, the Internet, wireless networks, cellular networks, and other private and/or public networks.

The sender 102 may be a person or an entity that may send a contract to a signer 122 for signature. In other words, the sender 102 may include a user of the electronic signature service 130 that may generate and send the contract to the signer 122. The sender 102 need not necessarily but may be a party to and may sign the contract. In comparison, the signer 122 may be a person or an entity singing the contract. In other words, the signer 122 may include a user of the electronic signature service 130 that may be a party to the contract and that may receive and sign the contract. Any or both of the sender 102 and the signer 122 may draft content of the contract. For example, the sender 102 and the signer 122 may negotiate terms of the contract, the sender 102 may draft the contract to include the terms, the signer 122 may provide feedback to the drafted terms, and the sender 102 and the signer 122 may sign the contract to memorialize an agreement to the terms of the contract.

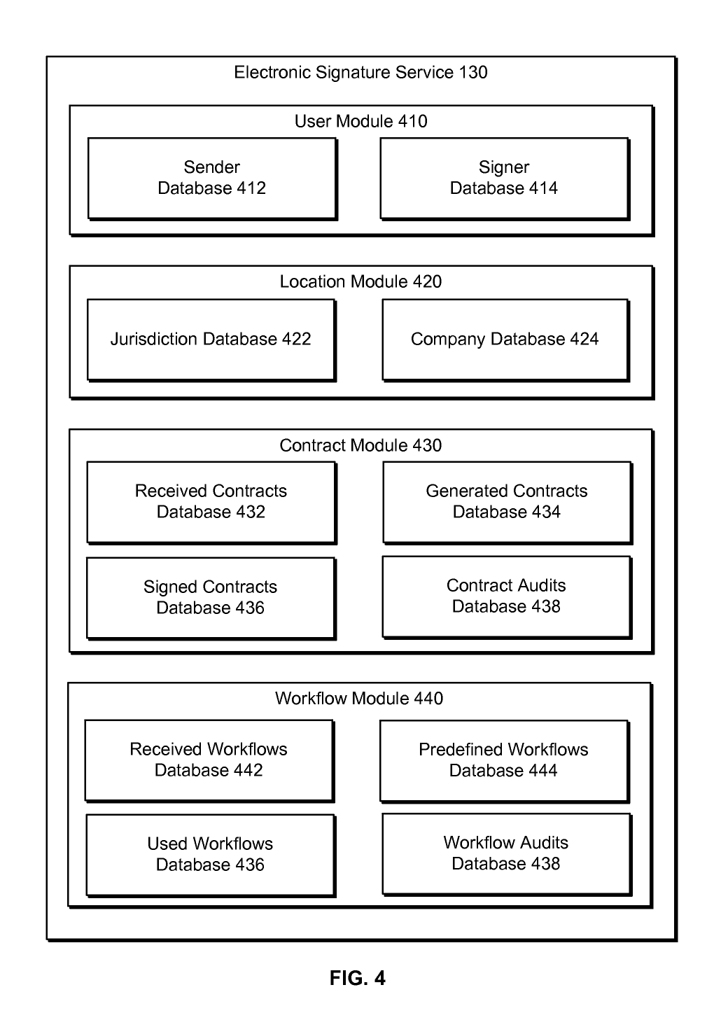

The electronic signature service 130 may be a network-based service (e.g., an online service) that may maintain information about the sender 102, the signer 122, requirements applicable to contracts, and other information, such that a contract that meets various relevant requirements can be presented to and signatures can be received from the sender 102 and the signer 122. The electronic signature service 130 may be implemented as a module within a document processing tool such as EchoSign® from Adobe®. FIG. 4 illustrates an example computing architecture for implementing the electronic signature service 130.

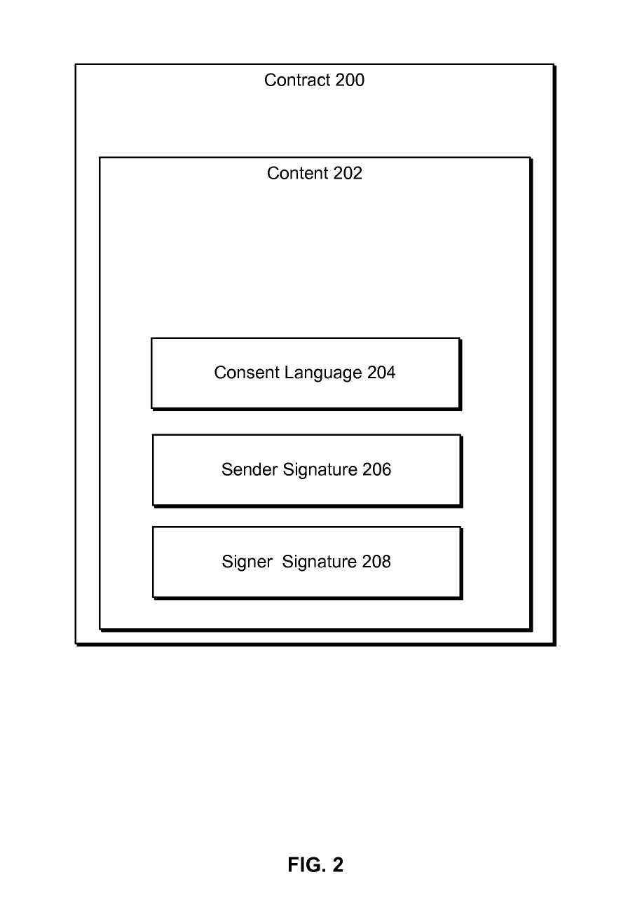

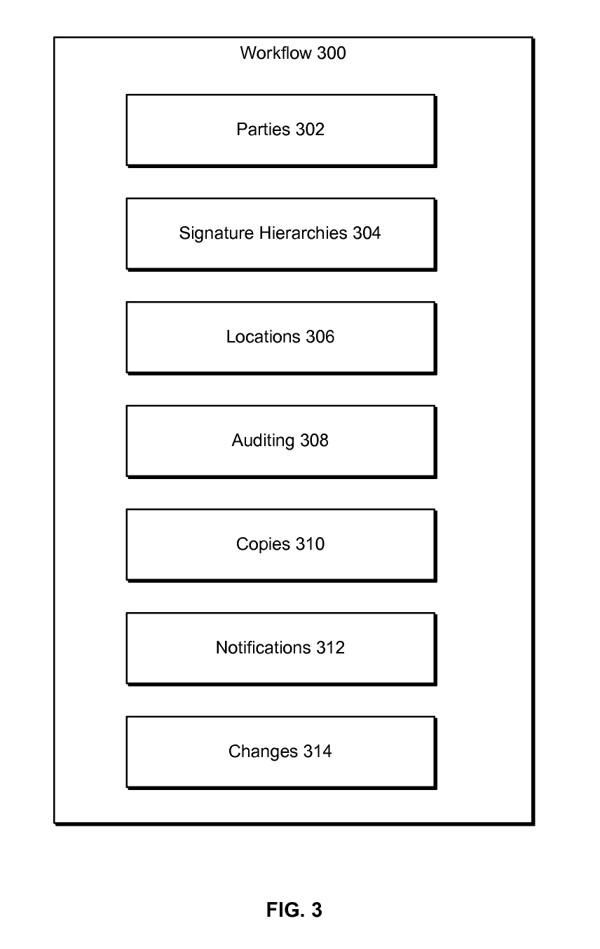

The contract may be an electronically represented document that may be exchanged between the sender 102 and the signer 122. The electronic signature service 130 may facilitate this exchange and may ensure that the contract, the workflow associated with the contract, and the signatures of the sender 102 and the signer 122 meet applicable requirements, including location-based requirements. FIGS. 2 and 3 illustrate examples of a contract and a workflow, respectively.

To be a binding contract, the contract and/or the workflow may need to meet certain requirements. These requirements may vary between locations and, thus, may be location-based or location-dependent. Each location may represent geographical boundaries or jurisdictions such as ones defined by national, international, or intra-national borders. An example of national borders may include the jurisdiction of the United States of America, Italy, or Japan. Similarly, an example of international borders may include the jurisdiction of the European Union. An example of intra-national borders may include the jurisdiction of California or Texas. Such jurisdictions may have different requirements as to the form, structure, content, and signatures of a contract and/or a workflow associated with the contract.

In addition to or in lieu of a jurisdiction, each location may represent a physical boundary or a virtual boundary. An example of a physical boundary may include location of two offices of a company: a location of a headquarters in one city (or on one floor of a building) and a location of a satellite office in another city (or on another floor of the same building). An example of a virtual boundary may include a virtual wall that may separate two offices of a company (e.g., sales and engineering) that may, in some situations, be located at the same physical location. Such companies may have requirements that may vary across the physical and/or virtual boundaries. For example, each office of a same company may define its own requirements as to what constitutes a valid contract (e.g., what type of signatures may be acceptable, who may need to sign, and aspects of a workflow). Thus, the company as a whole may have different requirements that may vary between the physical and/or virtual boundaries of the offices.

Further, in an example, the requirements may include legal requirements such that, when the contract and workflow are in compliance, the contract may be legally binding. These legal requirements may be defined by the jurisdictions where the contract should be legally binding. In another example, the requirements may include non-legal requirements. For instance, these requirements may be based on procedures or policies of a company, on personal preferences of the sender 102 and/or signer 122, or other non-legal requirements.

To facilitate the interaction with the sender 102 and the signer 122, the service provider 132 may configure the electronic signature service 130 to receive and process contract information 106 and contract information 126 from the sender 102 and the signer 122, respectively. For example, the electronic signature service 130 may provide an interface to the sender 102 to input the contract information 106 and an interface to the signer 122 to input the contract information 126. Each of the interfaces may be customized based on information about the respective user, such as the role of the user (e.g., a sender, a signer, a representative of a signer, and other functions).

In an example, the contract information 106 may include the contract. In other words, the sender 102 may generate the contract locally at the computing device 104 and may upload the generated contract to the electronic signature service 130 using the interface. Subsequently, the electronic signature service 130 may modify the uploaded contract to meet the applicable requirements. In another example, the contract information 106 may include information about the contract. In this example, the sender 102 may interact with the electronic signature service 130 via the interface to select a contract template and to specify various contract terms. In this example, the electronic signature service 130 may generate the contract and, as generated, the contract may at least the requirements applicable at the location of the sender 102.

In both examples, the contract information 106 may also include information about a workflow, about the signer 122, and the additional location 140. For instance, the sender 102 may specify a series or an order of actions that should be performed in conjunction with receiving signatures to the contract. Similarly, the sender 102 may identify the signer 122 using a user name, a nickname, an account number, an email address, or any other types of identifying information. Also, the sender 102 may identify the additional location 140 by providing a short description (e.g., Japan, Company ABC in New York, or Office XYZ of Company ABC). Further, the contract information 106 may include a signature of the sender 102 indicating assent to the terms of the contract.

On the other hand, the contract information 126 received from the signer 122 may include similar type of information. For example, the signer may identify the location 140 or another location, may modify or add to the workflow, or may edit the contract. This may allow the two parties (the sender 102 and the signer 122) to collaborate on the contract. In another example, the contract information 126 may be limited to other types of information. For instance, the contract information 126 may include a location, if needed, and a signature of the signer 122.

The electronic signature service 130 may be configured to process the contract information 106 and the contract information 126 such that a contract that meets the applicable requirements may be presented to the sender 102 and the signer 122, signatures may be received from the sender 102 and the signer 122, and workflow actions may be executed. For example, based at least in part on the contract information 106 and the contract information 126, the electronic signature service 130 may determine the locations of the sender 102 and the signer 122 and the additional location 140, may determine the corresponding requirements, and may accordingly generate or update the contract and workflow.

As illustrated in FIG. 1, the sender 102 may be located in the United States of America, the signer 122 may be located in the European Union (e.g., Italy), and the additional location 140 may include Japan. Each of these jurisdictions may have different requirements that may apply to the contract, including what types of electronic signatures may be legally binding, what contractual statements may be required, and what actions may need to be performed.

For example, the laws of the United States of America may recognize various types of electronic signatures but may require a positive assent statement along the lines of “I hereby certify that I have read, understood, and agree to the terms of the contract.” In comparison, the laws of the European Union may only recognize cryptographic digital signatures that may use a digital certificate, where such digital certificate may need to chain up to a trusted root certificate issued by a European Certificate Authority. The laws of Japan, on the other hand, may require an audit trail that tracks changes to the contract to be provided to a Japanese government agency. The described laws herein are for illustrative purposes and are used to exemplify that different jurisdictions can have different legal and other requirements applicable to a contract and/or a workflow, such as to the associated form, structure, content, and signatures of the contract and/or workflow.

Without using the electronic signature service 130, it may incumbent on the sender 102 and/or the signer 122 to know the various location-based and other requirements and to ensure that the contract and the workflow meet these requirements. In comparison, by using the electronic signature service 130, the sender 102 and/or signer 122 need not know the various-location based and other requirements. Instead, the electronic signature service 130 may automatically determine and ensure that the contract and the workflow comply with these requirements.

To illustrate and continuing with the previous example of the jurisdictions of the United States of America, the European Union, and Japan, using knowledge about the locations of the sender 102 and the signer and the additional location 140, the electronic signature service 130 may automatically determine which jurisdictions the contract should be recognized in, and modify the contract context and/or workflow to meet the requirements of these jurisdictions. For instance, the electronic signature service 130 may add the positive assent statement to the contract, may update the signer's 122 signature field to only accept a proper digital certificate, may present the contract as modified to the sender 102 and the signer 122. Further, the electronic signature service 130 may receive required signatures, may add a description of the changes to an audit trail of the contract, and may provide a copy of the audit trail to the Japanese government agency.

Turning to FIG. 2, that figure illustrates an example contract 200 that the electronic signature service 130 may process for the sender 102 and the signer 122. More particularly, the contract 200 may include content 202. Various terms of the contract and other information that may memorialize an agreement between the sender 102 and the signer 122 may be listed under the content 202.

Additionally, the contract 200 may include consent language 204, a sender signature 206, and a signer signature 208, each of which may include one or more fields for inputting information such that the contract may meet certain location-based requirements. For example, the consent language 204 may be a field that the electronic signature service 130 may update to include a proper consent statement. The sender signature 206 and the signer signature 208 may correspond to fields where sender 102 and signer 122 may input their signatures, respectively. The consent language 204, the sender signature 206, and the signer signature 208 may be located in multiple portions, sections, or pages within the content 202.

The electronic signature service 130 may configure the signature fields (e.g., sender signature 206 and signer signature 208) to accept various types of electronic signatures. In general, an electronic signature may be information that may represent an assent of a user (e.g., the sender 102 or the signer 122) to the contract 200. For example, an electronic signature may be electronic data representing a click-through response (e.g., clicking an acceptance/agree button), a typed signature, a computer generated signature for a user, a scanned signature for a user, a faxed signature of a user, a voice recording, a finger swipe, a photo or video of a user, a biometric reading (e.g., finger print, iris scan, voice print, or another biometric measure) or any other data that may indicate that a user agrees to the content 202. An electronic signature may also include a digital signature.

A digital signature may employ asymmetric cryptography techniques and may use certain hardware (e.g., a smartcard, a universal serial bus (USB) dongle, or other hardware), software (e.g., a certain cipher suite such as one that may implement a data encryption algorithm (DEA) or other cryptography algorithm), and/or a public key infrastructure (PKI). For example, a certificate authority may issue a digital certificate stored on a smartcard to the signer 122. To digitally sign the contract 200, the signer 122 may attach the smartcard to the computing device 124 and may operate an interface to the electronic signature service 130. In turn, the electronic signature service 130 may access the digital certificate on the smartcard and may apply a one-way cryptographic hash of the content 202 and the digital certificate such that the contract 200 is digitally signed.

Further, metadata associated with the contract 200 may be embedded within or may be stored along with the contract 200. For example, the metadata data may include information descriptive of the content 202, authors of the contract 200, circumstances surrounding generating and signing the contract 200 (e.g., activities, tools, timestamps, and other information). In addition to maintaining this metadata, the electronic signature service 130 may also track and record changes to the contract 200 as an audit trail associated with the contract 200. The audit trail may be embedded in the contract 200, in the metadata, or may be maintained in a separate file. For example, as changes are made to the contract 200 to meet the location-based requirements, or when signatures are entered in the sender signature 206 and the signer signature 208, the electronic signature service 130 may include corresponding descriptive information in the audit trail.

Once the contract is presented and the required signatures are received, the contract 200 and the associated metadata and audit trail may be protected against tampering. For example, the electronic signature service 130 may digitally sign the contract 200, the metadata, and the audit trail using a digital certificate of the electronic signature service 130. In this way, the content 200, the consent language 204, the sender signature 206, the signer signature 208, the metadata, and the audit trail may be secured with the digital certificate of the electronic signature service 130 and can be verified accordingly.

Turning to FIG. 3, that figure illustrates an example workflow 300. More particularly, the workflow 300 may include a number of actions that should be performed when generating and entering in the contract 200. The workflow in general, and some or all of the actions in particular, may need to meet location-based and other requirements.

The workflow 300 may be defined by the sender 102, the signer 122, and/or the electronic signature service 130. For example, the sender 102 may identify a number of actions that should be executed in association with electronically signing the contract 200. In this example, the sender 102 may identify the signer 122, specify an order of electronic signatures (e.g., when there are multiple signers), indicate whether the electronic signature service 130 can modify the contract 200 or the workflow 300 to meet location-based and other requirements, request that a copy of the signed contract 200 be stored at a certain server or other location, and specify other type of information pertinent to the execution and handling of the contract 200. Similarly, when notified of the contract 200, the signer 122 may further define other actions or modify some of the actions defined by the sender 102. For example, the signer 122 may identify additional signers or may modify the order of electronic signatures. Additionally, the electronic signature service 130 may define or modify other actions based, on for example, location-based requirements. For example, if a location-based requirement specified by the sender 102 or signer 122 dictates an auditing of the contract 200, the electronic signature service 130 may modify the workflow 300 to perform such auditing. These and other features of the workflow 300 are further described herein next.

As explained above, some or all of the actions may be specified by, for instance, the sender 102, the signer 122, and/or the electronic signature service 130. Also, some or all of the actions may be derived and/or modified based on the applicable requirements. For example, the sender 102 may identify at an interface to the electronic signature service 130 the parties to the contract 200, the hierarchy of the signatures, and locations where the contract 200 may be relevant. Similarly, the signer 122 may identify at an interface to the electronic signature service 130 that a copy of the contract 200 should be stored at a certain server. Additionally, based on the various applicable location-based requirements, the electronic signature service 130 may determine that auditing of the contract 200 may be required.

The workflow 300 may include identifiers of the parties 302 that should sign the contract 200. These identifiers may include identifiers of the sender 102, the signer 122, and other parties to the contract. The workflow 300 may also include a signature hierarchy 304. For example, when multiple signatures are required, the signature hierarchy 304 may specify the order in which the signatures may need to be collected (e.g., in what order the parties need to sign the contract 200).

The workflow 300 may also include identifiers of locations 306. This may include any additional location, in addition or in lieu of the location(s) of the parties, where the contract 200 may be relevant. Further, the workflow 300 may include an indication of whether auditing 308 of the contract 200 and/or the workflow 300 is required. If so, the workflow 300 may include a process executable to track changes made to the contract 200 and/or the workflow 300 and may associate the resulting information with the contract 200 (e.g., by adding an audit trail to the metadata of the contract 200).

In addition, the workflow 300 may include an indication as to whether copies 310 of the contract 200 should be distributed, and if so, who may be the recipients. Similarly, the workflow 300 may include information about required notification 312. For example, when changes are made to the contract 200, a notification 312 may identify whether the sender 102/or the signer 122 should be notified. Similarly, when signatures are received, a notification 312 may identify whether certain entities or agencies should be notified.

The workflow 300 may also include information indicative of whether changes 314 to the contract 200 and/or the workflow 300 are allowed or pre-authorized and, if so, the scope or extent of such changes. For example, the sender 102 may allow the electronic signature service 130 to change the type of acceptable signatures for the sender signature 206 and the signer signature 208 but may prohibit changes to the consent language 204. As such, if the electronic signature service 130 determines that changes to these fields are required to meet the applicable requirements, the electronic signature service 130 may only automatically change the sender signature 206 and the signer signature 208, may not automatically change the consent language 204, and may return the contract 200 as modified to the sender 102 with an indication that the consent language 204 may need further updates.

This list of actions of the workflow 300 is illustrative and is not exhaustive. One of ordinary skill in the art may appreciate that the sender 102, the signer 122, and/or the electronic signature service 130 may specify other actions.

As described above, the electronic signature service 130 may modify the contract 200 and/or the workflow 300 to meet the applicable requirements. FIG. 4 illustrates an example computing architecture of the electronic signature service 130. More particularly, the electronic signature service 130 may include various modules such as a user module 410, a location module 420, a contract module 430, and a workflow module 440, each of which is described herein next. These modules may be interconnected such that the contract 200 and/or the workflow 300 may be modified to meet applicable location-based and other requirements.

The user module 410 may host an interface that can be presented to a user (e.g., a sender 102 or a signer 122) to allow the user to provide contract-related information and user-related information. The contract-related information may include contract information 106 when the user is a sender 102 and contract information 126 when the user is a signer 122. The user-related information may be information about the user, such as a user name, a password, profile information, and other information. Such information may be stored at a database. As shown in FIG. 4, the user module 410 may have access to a sender database 412 for storing information about a sender and a signer database 414 for storing information about a signer. These databases may be stored on a storage device internal to the server 134 that hosts the electronic signature service 130 or on a storage device accessible to the electronic signature service 130 over a network.

Generally, the user module 410 may configure the interface to allow a sender (e.g., a sender 102) to perform a number of operations such as creating a profile (an account that stores sender information, logging-in using the profile or using the electronic signature service 130 as a guest, uploading a contract, creating a contract, specifying a workflow, specifying a number of locations (e.g., a location of the sender, a location of a signer, other locations where the contract may be relevant), specifying what changes to a contract can be made, specifying what changes to a workflow can be made, signing a contract, and paying for using the electronic signature service 130. The user module 410 may also configure an interface to provide similar or different operations to a signer. For example, the interface may allow a signer to create a profile and log-in accordingly, use a service as a guest, receive a contract, specify a location, specify a change to the contract and/or workflow, sign a contract, and pay for using the electronic signature service 130. Further, the user module may determine, based on identifiers of the users (e.g., the sender, the signer, or other users), requirements that may be specific to the users. These requirements may be stored at the sender database 412 and/or the signer database 414.

The location module 420 may be configured to determine a number of locations where the contract may be relevant and the corresponding location-based requirements. Various techniques may be used to determine a location. For example, the location module 420 may retrieve a location of a sender from the sender database 412 and a location of a signer from the signer database 414. In another example, a sender and/or a signer may enter locations at an interface (e.g., the interfaces facilitated by the user module 410) to provide the locations to the location module 420. In yet another example, if a location of a user (e.g., a sender or a signer) is not entered by the user, the location module 420 may determine a location of a computing device that the user is operating to connect to the electronic signature service 130 (e.g., a computing device 104 of a sender and a computing device 124 for a signer 122). For example, the location module 420 may receive global positioning system (GPS) coordinates (or any other satellite-generated coordinates), network-based location (e.g., cell tower triangulation, WiFi triangulation, internet protocol (IP) geolocation), or other location information of the user's computing device.

Once the locations are determined, the location module 420 may determine applicable location-based requirements. For example, the location module 420 may have access to a jurisdiction database 422 and a company database 424. These databases may be stored on a storage device internal to the server 134 that hosts the electronic signature service 130 or on a storage device accessible to the electronic signature service 130 over a network. Further, the jurisdiction database 422 and/or the company database 424 may be maintained by the service provider 132 of the electronic signature service 130 and/or by another party. Using the determined locations, the location module 420 may retrieve the corresponding requirements from the jurisdiction database 422 and/or the company database 424 and may unify these requirements in a rule set that can be applied to the contract and the workflow. If there are conflicting requirements that cannot be combined (e.g., one jurisdiction requires a digital signature while another jurisdiction prohibits using digital signatures), the location module 420 may identify and provide notifications of such conflicts.

The jurisdiction database 422 may contain jurisdiction-based requirements that may define requirements applicable to a contract, such as required contract language, signature types, and workflow actions. Similarly, the company database 424 may contain similar requirements that may be company-based rather than jurisdiction-based. Various users may define these requirements using various techniques. For example, a service provider associated with the electronic signature service 130 (e.g., a service provider 132) may determine the requirements of each jurisdiction and may store such information in the jurisdiction database 422. In another example, an authority associated with a jurisdiction may enter the corresponding jurisdictional requirements in the jurisdiction database 422 by way of, for instance, an interface that the electronic signature service 130 may host. Similarly, an administrator of a company may use a similar interface to enter requirements of the company. In yet another example, a sender may be an employee of a company (such information may be stored in the sender database 412) and may enter certain requirements of the company when using the electronic signature service 130 to generate a valid contract. The electronic signature service 130 may store these requirements in the company database 424 and, over time as more employees use the electronic signature service 130, may build a full or a near full set of requirements specific to that company.

The contract module 430 may be configured to perform various contract-related operations. For example, the contract module 430 may allow a user (e.g., a sender) to specify a contract, may edit the contract to meet applicable requirements, and may audit the contract.

To specify a contract, the contract module 430 may be configured to allow a user to upload a contract to the electronic signature service 130 or to use an interface of the electronic signature service 130 to create a contract. For example, the contract module 430 may interface with the user module 410 such that the interface presented to the user may allow this functionality. More particularly, a sender (e.g., a sender 102) may operate a computing device that interfaces with the electronic signature service 130 over a network (e.g., a computing device 104) and may use a tool local to the computing device to create the contract and to upload the contract to the electronic signature service 130. In another example, the sender may use the electronic signature service 130 to remotely create a contract, without locally creating and uploading the contract. In this case, the contract module may present a contract template to the user over the interface, may allow the user to edit portions, sections, or fields of the contract template, and may generate the contract accordingly.

Further, the contract module 430 may store a received contract in a received contracts database 432 and a generated contract in a generated contracts database 434. The databases 432 and 434 may be stored on a storage device internal to the server 134 that hosts the electronic signature service 130 or on a storage device accessible to the electronic signature service 130 over a network. As further explained herein below, to meet the applicable requirements, a received contract may be updated after being received, whereas a generated contract may be generated based on the requirements (e.g., the generated contract may automatically meet the requirements without needing further updates).

To edit a contract to meet applicable location-based and other requirements, the contract module 430 may identify the user, determine the relevant locations, and use this information to generate a rule set that combines the corresponding requirements. To do identify the user and determine the relevant locations, the contract module 430 may use various techniques. In an example, the contract module 430 may interface with the location module 420 to determine the locations and to retrieve the corresponding location-based requirements and/or rule set. Similarly, the contract module may interface with the user module 410 to determine identifiers of the users and to retrieve user-specific requirements and/or rule set. In another example, the contract module 430 may parse the contract to determine from the contract the locations and the identifiers. For instance, if the contract includes a clause describing a governing law jurisdiction and identifies the users, the contract module 430 may extract and use this information to interface with the location module 420 and the user module 410 to retrieve the applicable requirements and/or rule sets.

Once retrieved, the contract module 430 may unify the applicable requirements and/or rule sets in a single rule set. The contract module 430 may parse the content of the contract to determine whether the contract meets this rule set. If so, the contract module 430 may not modify the contract. Otherwise, the contract module 430 may edit the contract, as allowable, to meet the rule set. If a certain edit cannot be performed because of a certain conflict (e.g., a sender specifies that the electronic signature service 130 may not modify a signature field but the rule set indicates that the signature field should be changed), the contract module 430 may identify and provide a notification of this conflict. In addition to this type of notification, the contract module 430 may track edits to the contract and may provide notifications and/or summaries of these edits.

To illustrate, when a contract is received from a user, the contract module 430 may apply text recognition, optical character recognition (OCR), or other techniques to determine the content of the contract. The content may be searched and cross-checked against the requirements defined by the rule set. For example, if the rule set requires language that states “I hereby certify that I have read, understood, and agree to the terms of the contract” but such language is not found in the contract, the contract module 430 may determine that the contract needs to be modified and, if authorized, may modify the contract accordingly. In another example, if the rule set requires a certain type of signature (e.g., a digital signature), the contract module 430 may add a tag to a signature field of the contract such that, when the contract is presented for signature, the tag may only allow a proper signature to be added to or inserted in the signature field. In yet another example, if the rule set requires two types of signatures, such as an entry by some drawing means (e.g., drawing a signature or entering a scanned signature) and a typed entry (e.g., a typed name), and the contact only presents an input region for one of the two types of signatures, the contract module 430 may use whitespace finding and automatically add the necessary input region.

In another illustration, when a contract is remotely created using the electronic signature service 130, the contract module 430 may select and present a contract template to the user for editing. If the applicable rule set is available at that time (e.g., the location-based requirements are known at that time), the electronic signature service 130 may use the rule set to generate the contract such that the contract may automatically meet the requirements (e.g., by selecting a contract template that meets the rule set and allowing the user to only perform edits that meet the rule set). As such, no further updates may be needed for the contract. Otherwise, the generated contract may subsequently be updated to meet the rule set. In this case, the electronic signature service 130 may parse and update the edits to meet the rule set. Similar techniques as described herein above (e.g., text recognition) may be applied for this purpose. Additionally or alternatively, because a contract template is used in this case, the contract template may be pre-configured such that edits made thereto may be compared to the rule set. For example, tags may be associated with the various editable fields of the contract, and when a field is edited, the contract module 430 may update a corresponding tag with a description of the edit. To determine if the edit meets the rule set, the contract module 430 may compare the description to the requirements of the rule set. If the requirements are not met, the contract module may update, if authorized, the edit accordingly.

To audit a contract, the contract module 430 may be configured to keep track of changes made to a contract. The contract module 430 may save the tracked changes in an audit trail that can be embedded in the contract, in the metadata of the contract, or in an audit file. Further, the contract module 430 may store the audit trail in a contract audits database 438. Similarly, when a contract is signed, the contract module 430 may store the signed contract in a signed contracts database 436. In this way, the contract module 430 may provide a user with access to audit information and records of a contract.

Also, the contract module 430 may use the signed contracts database 436 when auditing a contract. For example, by comparing a signed contract from the signed contracts database 436 to a corresponding contract from the received contracts database 432 or from the generated contracts database 434, the contract module 430 may determine changes made to the contract and may store these changes in an audit trail in the contracts audit database 438. The databases 436 and 438 may be stored on a storage device internal to the server 134 that hosts the electronic signature service 130 or on a storage device accessible to the electronic signature service 130 over a network.

The workflow module 440 may be configured to perform various workflow-related operations. For example, the workflow module 440 may allow a user (e.g., a sender, a signer) to specify a workflow associated with a contract, may edit the workflow to meet applicable requirements, and may audit the workflow.

To specify a workflow, the workflow module 440 may be configured to allow a user to use an interface of the electronic signature service 130 to create a workflow. For example, in conjunction with uploading a created contract or creating a contract, a sender may also specify a workflow for that contract. Similarly, in conjunction with receiving or signing a contract, a signer may specify a workflow or a modification to an already specified workflow for that contract. The workflow module 440 may interface with the user module 410 such that the interface presented to a user may allow this functionality. Also, the workflow module 440 may store received workflows (or modifications) in a received workflows database 442. In another example, a user need not specify a workflow. Instead, the workflow module 440 may select a predefined workflow from a predefined workflows database 444. The databases 442 and 444 may be stored on a storage device internal to the server 134 that hosts the electronic signature service 130 or on a storage device accessible to the electronic signature service 130 over a network.

To edit a workflow to meet applicable location-based and other requirements, the workflow module 440 may interface with the location module 420 and the user module 410 to retrieve an applicable rule set. For example, when a workflow is specified by a user, the workflow module 440 may parse and compare the workflow to the requirements of the rule set to determine whether the workflow meets the rule set. If so, the workflow module 440 may not modify the workflow. Otherwise, the workflow module 440 may modify the workflow, as allowable, to meet the rule set. If a certain modification cannot be performed because of a certain conflict (e.g., a sender specifies that a copy of the contract may not be stored with a third party but the rule set indicates that a copy should be provided to a certain third party such as a government agency), the workflow module 440 may identify and provide a notification of this conflict. In addition to this type of notification, the workflow module 440 may track edits to the workflow and may provide notifications and/or summaries of these edits.

In another example, if the workflow is generated from a predefined workflow and the location of the user is known (e.g., the applicable rule set is available), the predefined workflow may be selected to meet the location-based requirements of the applicable rule set. But if the location of the user is not known, the predefined workflow may be subsequently modified as needed to meet any subsequently identified requirements when the location becomes known.

To audit a workflow, the workflow module 440 may be configured to keep track of changes made to a workflow. The workflow module 440 may save the tracked changes in an audit trail that can be embedded in the contract, in the metadata of the contract, or in an audit file. Further, the workflow module 440 may store the audit trail in a workflow audits database 448. Additionally, when an action of a workflow is executed (e.g., the electronic signature service 130 performs an action specified in the workflow), the workflow module 440 may store an indication of the step in a used workflows database 446. In this way, the workflow module 440 may provide a user with access to audit information and records of a workflow. The databases 446 and 448 may be stored on a storage device internal to the server 134 that hosts the electronic signature service 130 or on a storage device accessible to the electronic signature service 130 over a network.

Although FIG. 4 illustrates the various modules of the electronic signature service 130 as separate modules, some or all of these modules may be combined. The various modules may be interconnected and/or combined such that the electronic signature service 130 may minimize the effort needed on behalf of a sender and/or a signer to generate a contract that meets applicable location-based and other requirements. More particularly, the sender and/or the signer need not be aware or have knowledge of these requirements. In other words, when specifying a contract or a workflow, the sender and/or the signer need not invest time and resources in determining what these requirements may be. Instead, the sender and/or the signer may turn to the electronic signature service to modify the contract and/or the workflow to meet the requirements.

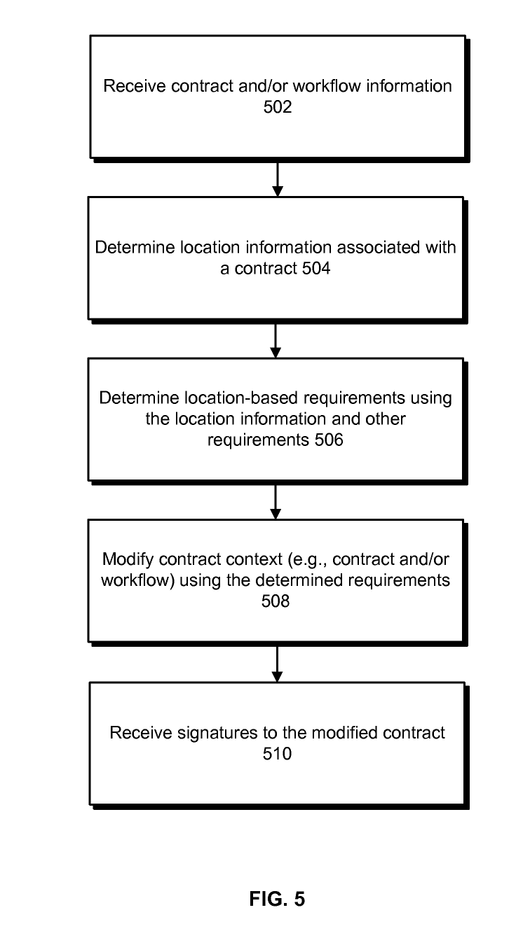

Turning to FIGS. 5, 6, and 7, those figures illustrate example flows for modifying a contract and/or a workflow by using location-based and other requirements. In the illustrative operations, each of the operations or functions may be embodied in, and fully or partially automated by, modules executed by one or more processors of a computing system hosting an electronic signature service (e.g., a server 134 hosting an electronic signature service 130). The modules may include, for example, a user module 410, a location module 420, a contract module 430, a workflow module 440, and other modules that the electronic signature service may implement. Also, while the operations are illustrated in a particular order, it should be understood that no particular order is necessary and that one or more operations may be omitted, skipped, and/or reordered. Further, in the interest of clarity of explanation, an electronic signature service is described as performing the illustrative operations. Nevertheless, other or additional modules of a computing system may be configured to implement one or more of the operations and/or one or more steps of the operations.

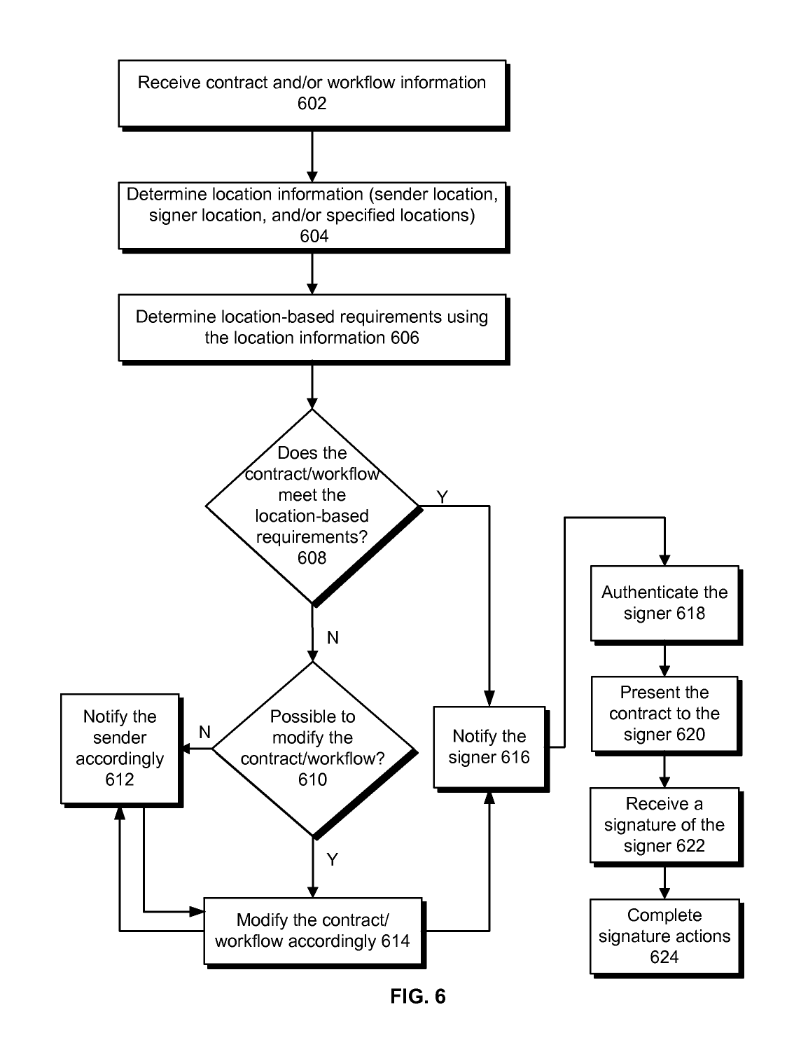

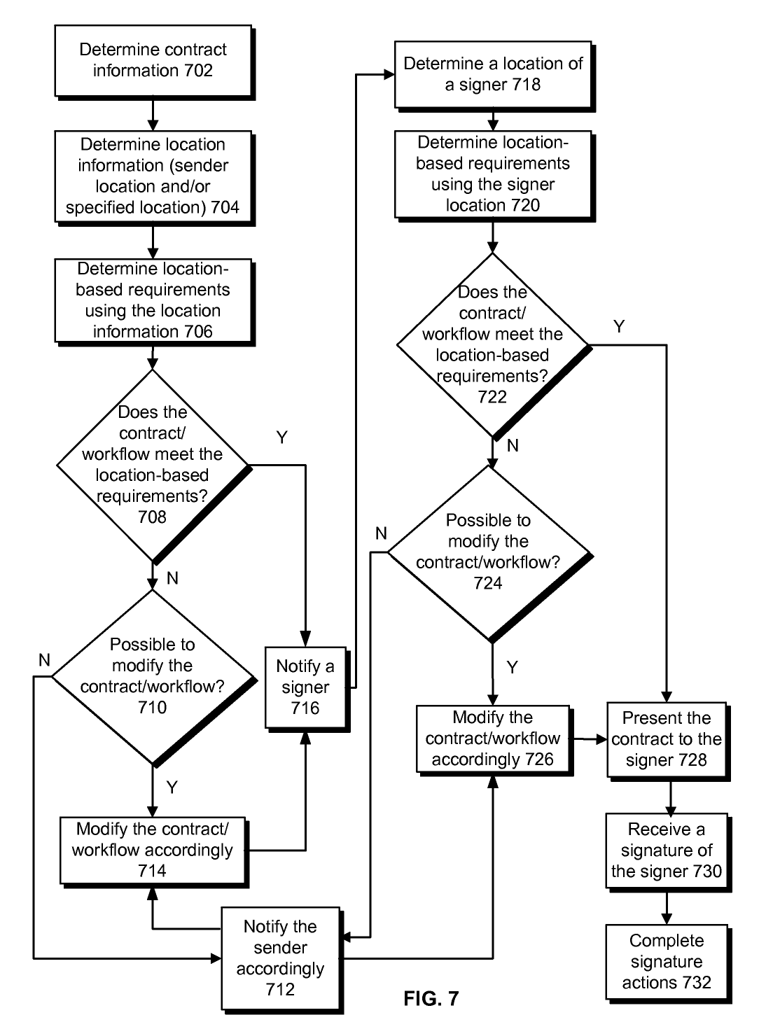

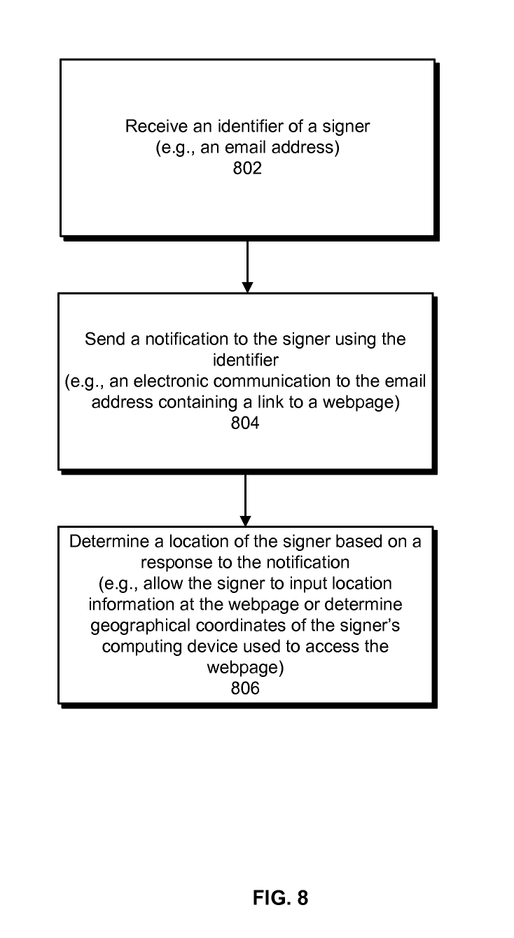

FIG. 5 illustrates an example flow that the electronic signature service may implement to determine the location-based and other requirements and to modify a contract and/or a workflow accordingly. Operations of the example flow of FIG. 5 may be further embodied in operations of example flows of FIGS. 6 and 7. As such, some operations of the example flows of FIGS. 5, 6, and 7 may be similar. Such similarities are not repeated herein in the interest of clarity of explanation. FIG. 6 illustrates an example flow for modifying a contract and/or a workflow when location information of a signer is known prior to notifying the signer of the contract. In comparison, FIG. 7 illustrates an example flow for further modifying a contract and/or a workflow when the location information of the signer is not known until such a notification. An example flow for determining the location information of the signer is shown in and described with respect to FIG. 8. Further, while the operations in the example flows are performed, the electronic signature service may store information descriptive of circumstances associated with performing the operations (e.g., changes made to a contract and associated times, identifiers of the software tools used, and other circumstances). This information may be stored as an audit trail.

In the interest of clarity of explanation, an example use case is described in the flows of FIGS. 5, 6, and 7, where a sender is located in the United States of America, a signer is located in Italy, and the contract needs to be enforced in the United Stated of America, the European Union, and Japan. For illustrative purposes, this use case exemplifies that various jurisdictions may have various requirements. As illustrated, the laws of the United States of America may require a positive assent language in the contract but may accept any type of signatures, the laws of the European Union may require a digital signature issued by an Italian certificate authority, and the laws of Japan may require that a copy of the signed contract is sent to a Japanese government agency. However, the example flows are not limited to this use case. Instead, the electronic signature service may implement the example flows for other and different numbers of locations, users, and requirements.

Turning to FIG. 5, the example flow starts at operation 502, where the electronic signature service may receive contract and/or workflow information. For example, a sender may operate a computing device to remotely log-in and use one or more services of the electronic signature service. The electronic signature service may facilitate these services by way of one or more interfaces. The sender may use an interface to upload an already created contract or to create a contract. Similarly, the sender may use the interface to specify the workflow associated with the contract.

At operation 504, the electronic signature service may determine location information associated with a contract. For example, the electronic signature service may determine a location of the sender (e.g., the United States of America), a location of a signer (e.g., Italy), and other locations where the contract may be relevant (e.g., in addition to the United States of America and Italy, these locations may be the European Union and Japan).

As explained above, a combination of various techniques may be used to determine the location information. For example, the electronic signature service may present an interface to the sender that, in turn, may use the interface to input this information. In another example, the sender may login to the electronic signature service using an identifier (e.g., a user name, an email address, or other identifiers) and may identify the signer (e.g., using a user name, an email address, or other identifiers of the signer). In turn, the electronic signature service may use the identifiers to query and retrieve from one or more databases (e.g. a sender database 412 and a signer database 414) the locations of the sender and the signer (e.g., the respective home or employment addresses). In yet another example, if the sender and/or signer are not pre-registered with the electronic signature service (e.g., no corresponding profiles are stored in a sender database 412 and/or a signer database 414), the electronic signature service may determine the locations of the computing devices that the sender and signer operate (e.g., using GPS coordinates or other satellite or network-based locations). In a further example, the electronic signature service may parse the contract to determine one or more of the locations. For example, if the contract includes a clause describing a governing law jurisdiction, the electronic signature service may use that jurisdiction as a relevant location.

At operation 506, the electronic signature service may determine applicable requirements. These requirements may include location-based requirements and other requirements. The electronic signature service may use the location information determined at operation 504 to determine the location-based requirements. For example, the electronic signature service may use the location information to query and retrieve from one or more databases (e.g., a jurisdiction database 422 and/or a company database 424) requirements that may apply for each location, where the requirements may specify required contract language, types of signatures, and/or workflow actions. Similarly, the electronic signature service may use information about the sender and/or signer available at operation 504 (e.g., identifiers of the sender and signer) to determine user-specific requirements. The electronic signature service may determine whether there are any conflicts between the applicable requirements. If so, the electronic signature service may notify the sender and/or signer accordingly. This may include sending a communication (e.g., an email) to the sender/or signer with information descriptive of the conflicts. Otherwise, the electronic signature service may unify the requirements into a rule set that may be applied to the contract and/or workflow. In the use case example, the rule set may require the contract to include positive assent language, the signature field of the signer to accept only a digital signature generated with a digital certificate issued by an Italian certificate authority, and a copy of the signed contract to be sent to a Japanese government agency.

At operation 508, the electronic signature service may modify the contract and/or the workflow using the applicable requirements. More particularly, the electronic signature service may apply the rule set to the contract and/or the workflow such that the contract and/or the workflow meet the applicable requirements. The electronic signature service may perform such modifications automatically or may require approval from the sender. As explained herein above, the sender may specify in the workflow a pre-authorization for the electronic signature service to perform certain modifications and not others as well as notification requirements. As such, for required modifications that are pre-authorized, the electronic signature service may automatically modify the contract and/or the workflow and may notify the sender accordingly. For required modifications that are not pre-authorized, the electronic signature service may present descriptions of these modifications to the sender and may receive corresponding approval or further edits from the sender. In the example use case, if the electronic signature service determines that the positive assent language is already in the contract but that the signature field is not limited to a digital signature and that the workflow does not specify that the Japanese government agency requires a copy of the contract, the electronic signature service may modify the signature field of the signer to only accept the required digital signature and the workflow to require a copy to be sent to the Japanese government agency and may notify the sender accordingly.

At operation 510, the electronic signature service may receive signatures to the modified contract. For example, the electronic signature service may present the contract to the sender and the signer by way of respective interfaces. In turn, the sender and the signer may use the respective interfaces to sign the contract. For example, the sender may input an electronic signature in a signature field of the sender. Similarly, the signer may input an electronic signature in the signature field of the signer. In the use case example, the electronic signature may only allow the signer to input a digital signature using a digital certificate issued by an Italian certificate authority. Otherwise, the electronic signature may reject the electronic signature of the signer. When the contract is signed, the electronic signature service may send a copy to the Japanese government agency.

Turning to FIG. 6, that figure illustrates an example flow for modifying a contract and/or a workflow for the contract when location information of a signer is known prior to notifying the signer of the contract. If a sender is a party to the contract, the location of the sender should also be considered in the example flow of FIG. 6. As further described below, various techniques can be used to determine the locations of the sender and signer. Briefly, an electronic signature service may provide an interface to the sender for interacting with the electronic signature service. The interface may include fields for inputting the relevant locations. Additionally or alternatively, the interface may include fields for inputting identifiers of the sender and the signer (e.g., by email address, username, or other type of identifications). In turn, the electronic signature service may use the identifiers to retrieve account information for the sender and signer from a user database. The account information can include the relevant locations. In yet another example, the electronic signature may derive the relevant locations directly from the contract. For instance, the electronic signature service may parse the contract for clauses and keywords specifying location information (e.g., a clause indicating addresses of the sender and signer or a clause describing governing law jurisdictions, etc.).

The example flow of FIG. 6 starts at operation 602, where an electronic signature service may receive contract and/or workflow information. This operation may be similar to operation 502. In an example, a sender may operate a computing device to connect to the electronic signature service. In turn, the electronic signature service may provide an interface to the sender usable for various actions. For example, the sender may use the interface to log-in to a sender account, to upload a created contract in a certain format (e.g., a WORD or a PDF document), to identify a signer, to specify a location(s) where the contract may be relevant (e.g., Japan and the European Union, in addition to the United States of America and Italy), and to identify aspects of the workflow (e.g., whether the electronic signature service may automatically modify the contract, whether the electronic signature service should notify the sender when a modification needs to be made, and other workflow actions).

At operation 604, the electronic signature service may determine location information associated with the sender, the signer, and/or other specified locations. This operation may be similar to operation 504. The electronic signature service may determine these locations using different techniques. In an example, the electronic signature service may retrieve the location of the sender from the sender account or from information that the sender enters at the interface (e.g., the interface may present a field where the sender may enter the location). In another example, the electronic signature service may determine the current physical location of the sender in real time by, for example, requesting and receiving from the computing device of the sender the computing device's geographic location (e.g., GPS coordinates). To determine the location of the signer, the electronic signature service may use an identifier of the signer entered by the sender at the interface to retrieve this location from a signer account. In another example, the sender may enter the location of the signer at the interface (e.g., the interface may present a field where the sender may enter the location). To determine other locations, the electronic signature service may allow the sender to specify these locations at the interface.

At operation 606, the electronic signature service may determine location-based requirements using the location information. This operation may be similar to operation 506. In an example, the electronic signature service may use each of the determined locations (e.g., the United States of America, Europe, and Italy) to retrieve the corresponding requirements. Further, the electronic signature service may compare the requirements to determine if there are any conflicts (e.g., some requirements may be mutually exclusive). If so, the electronic signature service may notify the sender of the conflict, may cancel the contract, or may return the contract to the sender for further review. Otherwise, the electronic signature service may generate a rule set based on the requirements usable for modifying the contract and/or workflow to conform to the various requirements.

At operation 608, the electronic signature service may determine whether the contract and/or workflow meet the location-based requirements. If so, the contract and the workflow need not be modified and, thus, the electronic signature service may perform actions of the workflow and may notify the sender of the contract as further described at operation 616. Otherwise, the contract and/or workflow should be modified to meet the location-based requirements. In this case, operation 610 may follow the operation 608.

At operation 610, the electronic signature service may determine whether the contract and/or the workflow may be modified. For example, by comparing the contract and/or workflow to the rule set, the electronic signature service may identify the required changes to the contract and/or workflow. In turn, the electronic signature may compare the required changes to what the sender has pre-authorized (e.g., based on what the sender specified at the operation 602). If it is possible to automatically perform the required changes (e.g., when the electronic signature service is pre-authorized), operation 614 may follow the operation 610. Otherwise, operation 612 may be followed, where the electronic signature service may notify the sender of the required changes. The notifications may be in the form of an electronic communication sent to the sender and containing information descriptive of the required changes (e.g., an email with the information or with a link to a web page hosted by the electronic signature service for providing the information). In turn, the sender may approve the required changes or may manually edit the contract and/or workflow with the required changes. At that point, the operation 614 may follow operation 612. Otherwise, the required changes cannot be made and the electronic signature service may cancel or may return the contract to the sender.

At operation 614, the electronic signature service may modify the contract and/or the workflow based on the required changes. For example, if the contract does not include a proper signature field for the signer and/or if the workflow does not specify that a copy should be sent to the Japanese government agency, the electronic signature may update the contract and/or workflow accordingly.

Once the contract and/or workflow meet the location-based requirements associated with the sender, the signer, and other specified locations, the workflow may be ready for execution and the contract may be ready for presentation to the signer. At that point, operation 616 may be performed, where the electronic signature service may notify the signer of the contract. For example, the electronic signature service may send an electronic communication to the signer (e.g., an email to an email address of the signer retrieved from the signer account). The electronic communication may inform the signer that a contract is available for signing and may provide a link to a web page that the electronic signature service hosts and that presents the contract. In this case, the signer may operate a computing device to connect to the electronic signature service to review and sign the contract as described at operations 618-620. Additionally or alternatively, the electronic communication may contain a copy of the contract. In this case, the signer may still use the electronic signature service to sign the contract or may sign the contract separately from the electronic signature service.

At operation 618, the electronic signature service may authenticate the signer. In an example, the signer may operate the computing device to follow the link to the web page associated with the contract, which may require an authentication of the signer. In response to the signer entering credentials (e.g., user name and password), the electronic signature service may authenticate the signer and connect the computing device to the web page. In another example, the signer need not follow the link. Instead, the signer may operate the computing device to connect as a guest at the electronic signature service, search for and find the contract, enter a code provided in the electronic communication, and access the contract.

At operation 620, the electronic signature service may present the contract to the signer. For example, the electronic signature service may present the contract at the web page or at an interface that the signer is able to connect to by way of the computing device.

At operation 622, the electronic signature service may receive a signature of the signer. For example, the signer may input a signature in a signature field of the contract. In the example use case, because the signer is in Italy and the jurisdictional requirements of the European Union are such that the signer must digitally sign the contract using a certificate issued by an Italian certificate authority, the electronic signature service may reject any signature from the signer that does not meet this requirement. In other words, the electronic signature service may inform the signer of the type of acceptable signature and may only allow the signer to input a signature in the signature field that meets the acceptable signature type.

At operation 624, the electronic signature service may complete any other signature actions. This may include performing remaining actions of the workflow. For example, the electronic signature service may notify the sender of the signer's signature, may receive the sender's signature, and may send a copy of the signed contract to the Japanese government agency. In another example, the workflow may require an audit trail to be generated and various records thereof to be distributed. For instance, the requirements of the United States of America may specify that an audit trail be stored at a server in the United States of America. Similarly, the requirements of Italy may specify that an Italian government office be notified when a digital certificate issued by the Italian certificate authority is used. As each of the operations 602-624 is performed, the electronic signature service may store information descriptive of circumstances for performing the operations as a record or metadata of an audit trail, and may complete the workflow. As such, the electronic signature service may store a copy of the audit trail at a server located in the United States of America and may send a copy of the record indicating the signer's signature to the Italian government agency.

Hence, by performing the example flow of FIG. 6, the electronic signature service may receive information about a contract and relevant locations from the sender. In turn, the electronic signature service may determine the various applicable requirements based on the locations and may, if agreed to (e.g., pre-authorized or authorized post notification), automatically update the contract and the workflow based on these requirements. Also, the electronic signature service may perform the various actions of the workflow including receiving the required signatures, storing various records associated with the contract, and distributing the various records to required parties and entities.

Turning to FIG. 7, that figure illustrates an example flow for modifying a contract and/or a workflow when a location of a signer is not known until the signer is notified that the contract is available. Unlike the example flow of FIG. 6, where the location of the signer is known ahead of time such that contract and/or workflow may be modified prior to notifying the signer, the example flow of FIG. 7 may be performed when the location of the signer is not initially known. In this example flow, the modification of the contract and/or workflow can be done in two phases. In a first phase, the contract and/or workflow can be modified based on information about a location of a sender and/or additional specified locations. In a second phase, the signer can be notified of the contract, the location of the signer can be subsequently determined, and the contract and/or workflow may be further modified based on this determined location. This modification can be performed after the notification is sent, but before presenting the contract to the signer or can be performed after presenting the contract to the signer.

The example flow of FIG. 7 starts at operation 702, where an electronic signature service may determine contract information. This operation may be similar to operation 602, except that a sender at this operation may not specify a location of a signer.

At operation 704, the electronic signature service may determine location information associated with a sender and/or other specified locations. This operation may be similar to the operation 604, except that the electronic signature service may not determine the location of the signer. For example, the sender may not have provided the location information of the signer at the operation 702. In another example, the signer may not be pre-registered with the electronic signature service and, thus, the electronic signature service may not have prior knowledge of the signer's location.

At operation 706, the electronic signature service may determine location-based requirements using the location information. This operation may be similar to the operation 606, except that the location-based requirements would not include requirements associated with the signer's location.

At operation 708, the electronic signature service may determine whether the contract and/or the workflow meet the location-based requirements. This operation may be similar to the operation 608, except that this determination may not account for the requirements of the signer's location. If the contract and/or workflow meet the requirements, operation 716 may be followed where the electronic signature service may notify the signer of the contract. Otherwise, operation 710 may be followed.

At operation 710, the electronic signature service may determine whether the contract and/or workflow can be modified to meet the location-based requirements. This operation may be similar to the operation 610. If the contract and/or workflow cannot be modified, operation 712 may be performed. Otherwise, operation 714 may be performed.

At operation 712, the electronic signature service may notify the sender of the required changes. This operation may be similar to the operation 612. If the sender approves the required changes or edits the contract and/or workflow based on the required changes, the electronic signature service may modify the contract and/or workflow accordingly at operation 714. Otherwise, the electronic signature service may cancel or return the contract to the sender.

At operation 714, the electronic signature service may update the contract and/or workflow based on the required changes. This operation may be similar to the operation 614. At this point in the flow, the contract and the workflow may meet the requirements associated with the sender's location and any other specified location but not the requirements associated with the signer's location because this location and, thus, the corresponding requirements may not yet be known.

At operation 716, the electronic signature service may notify the signer of the contract. This operation may be similar to the operation 616. In an example, the electronic signature service may send an electronic communication (e.g., an email) to an address (e.g., an email address) of the signer. This address may have been provided by the sender at the operation 702. The electronic communication may include information descriptive of the contract and a link to a web page associated with the contract and hosted by the electronic signature service.

At operation 718, the electronic signature service may determine the location of the signer. An example flow for determining the location of the signer is further illustrated in FIG. 8. The electronic signature service may use this determined location as the location of the signer and may perform operations 720-726 before presenting the contract to the signer. In other words, the electronic signature service may further modify the contract and/or workflow based on the received location of the signer before presenting the contract to the signer such that, when the signer views the contract at the web page, the contract would have already been modified to meet the requirements associated with the location of the signer. Note that in some cases, the electronic signature service may determine a then-current physical location of the signer (e.g., geographical location from which the signer accessed the electronic signature service) and not the location of the sender's home office or other location that should be used for jurisdictional purposes. Therefore, it may be desirable to present the signer with an option to confirm or change the determined location (and thus undo any contract or workflow modifications that may have been made).

At operation 720, the electronic signature service may determine location-based requirements using the signer's location. This operation may be similar to the operation 706, except that the determined requirements may include the requirements of the signer's location.

At operation 722, the electronic signature service may determine whether the contract and/or workflow meet the location-based requirements of the signer's location. This operation may be similar to the operation 708, except that the contract and/or workflow may be compared to the requirements of the signer's location. As such, the determined changes at this operation are required changes associated with the signer's location. If the contract and workflow meet the requirements, operation 728 may be performed to present the contract to the signer. Otherwise, operation 724 may be performed to further modify the contract and/or workflow.

At operation 724, the electronic signature service may determine whether the contract and/or workflow can be modified to meet the required changes of the signer's location. This operation may be similar to the operation 710. If the contract and/or workflow can be modified, operation 726 may be performed to complete such changes. Otherwise, the operation 712 may be performed, where the sender may be notified of the required changes. If the sender approves the required changes or edits the contract and/or workflow accordingly, the electronic signature service may perform the operation 726 to complete the changes.

At operation 726, the electronic signature service may modify the contract and/or workflow based on the required changes. This operation may be similar to the operation 714, except that the contract and/or workflow may be further modified to incorporate the required changes of the signer's location. Once the operation 726 is complete, the contract may be ready for the signer to sign. In other words, at this point in the flow, the contract and/or workflow may have been updated to meet the various location-based requirements.

At operation 728, the electronic signature service may present the contract to the signer. This may be similar to the operation 620. For example, the electronic signature service may present the contract at the web page accessible to the signer by way of the computing device. Also at this operation, the electronic signature service may confirm the location of the signer (e.g., by presenting a field at the web page or at another interface asking the signer to confirm the determined location), may offer the signer an option to register (e.g., to create a signer account), and may register the signer accordingly. This can be done prior to presenting the contract. If the location is confirmed, the electronic signature service may store this location for uses associated with subsequent contracts. If the confirmation indicates a different location, the electronic signature service may re-perform the operations 720-726 and present a modified contract.

At operation 730, the electronic signature service may receive a signature of the signer. This operation may be similar to the operation 622. For example, the electronic signature service may allow the signer to sign the contract with a signature that meets the location-based requirements.

At operation 732, the electronic signature service may complete signature actions. This operation may be similar to the operation 624. For example, the electronic signature service may perform the remaining actions of the workflow.

Hence, even if the signer's location is not known when the contract is first uploaded to or created at the electronic signature service, the electronic signature service may nonetheless initially modify the contract and/or workflow based on the sender's location and any other specified location, and may subsequently further modify the contract and/or workflow based on the signer's location when this location becomes available. In this way, the electronic signature service may further minimize the effort of the sender because the sender need not even need to know the singer's location, let alone the requirements associated with this location.

Turning to FIG. 8, that figure illustrates an example flow for determining a location of a signer of a contract. An electronic signature service may perform the example flow of FIG. 8 when, for example, a sender of the contract does not identify the signer's location. The example flow starts at operation 802, where the electronic signature service may receive an identifier of the signer. For example, the electronic signature service may provide an interface to the sender for inputting an e-mail address of or other identifier associate with the signer.

At operation 804, the electronic signature service may use the identifier to send a notification to the signer. For example, the electronic service signature may generate and send an electronic communication addressed to the email address or other identifier of the signer. This communication may contain a link to a web page hosted by the electronic signature service.

At operation 806, the electronic signature service may determine the signer's location based on a response to the notification. This operation may include receiving an indication that the signer reviewed the communication and using this indication to determine the location. For example, the signer may operate a computing device to access the communication and may activate the link to access the webpage. In some embodiments, the webpage may include a field allowing the signer to input information about his/her location. In another example, the electronic signature service may receive an acknowledgement message indicating successful delivery of the message to the signer's computing device and/or that the signer's computing device has connected to a server hosting the electronic signature service. The acknowledgement message may indicate an IP address or other network identifier of the signer's computing device. The electronic signature service may invoke location based services, which may require the electronic signature service to interact with other server(s) and/or devices across a network, to request and receive a geographical location corresponding to the network identifier of the signer's computing device (e.g., geographic coordinates based on GPS, cell tower triangulation, WiFi triangulation, or IP geolocation). The electronic signature service may use this geographical location as the location of the signer.

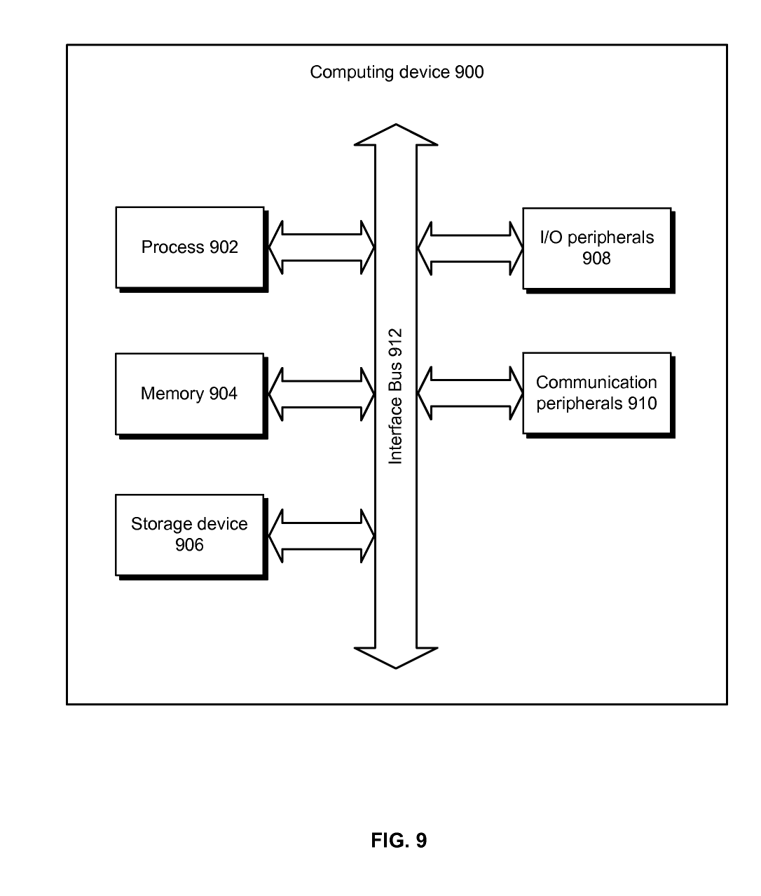

To implement the various features and functions described herein above, some or all elements of the computing devices (e.g., computing devices 104 and 124 and the server 134) may be implemented using elements of the computing device of FIG. 9. More particularly, FIG. 9 illustrates an example computing device 900 for implementing the techniques in accordance with the present disclosure.

The computing device 900 that may include at least a processor 902, a memory 904, a storage device 906, input/output peripherals 908, communication peripherals 910, and an interface bus 912. The interface bus 912 may be configured to communicate, transmit, and transfer data, controls, and commands among the various components of the computing device 900. The memory 904 and the storage device 906 may comprise computer readable storage media, such as random access memory (RAM), read-only memory (ROM), electrically erasable programmable read-only memory (EEPROM), hard-drives, CD-ROMs, optical storage devices, magnetic storage devices, electronic non-volatile computer storage, for example Flash® memory, and other tangible storage media. Any of such computer readable storage media can be configured to store instructions or program codes embodying aspects of the disclosure. The memory 904 and the storage device 906 may also comprise computer readable signal media. A computer readable signal medium may include a propagated data signal with computer readable program code embodied therein. Such a propagated signal may take any of a variety of forms including, but not limited to, electromagnetic, optical, or any combination thereof. A computer readable signal medium may be any computer readable medium that is not a computer readable storage medium and that can communicate, propagate, or transport a program for use in connection with the computing device 900.

Further, the memory 904 may comprise an operating system, programs, and applications. The processor 902 may be configured to execute the stored instructions and can comprise, for example, a logical processing unit, a microprocessor, a digital signal processor, and other processors. The input and output peripherals 908 may include user interfaces such as a keyboard, screen, microphone, speaker, other input/output devices, and computing components such as graphical processing units, serial ports, parallel ports, universal serial bus, and other input/output peripherals. The input/output peripherals 908 may be connected to the processor 902 through any of the ports coupled to the interface bus 912. The communication peripherals 910 may be configured to facilitate communication between the computing device 900 and other computing devices over a communications network and may include, for example, a network interface controller, modem, wireless and wired interface cards, antenna, and other communication peripherals.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

1. A computer-implemented method comprising:
determining, by a computing service configured to facilitate electronic signatures for electronic documents, location information associated with a user requested to electronically sign an electronic document;
determining, by the computing service, one or more requirements for electronically signing the electronic document, the one or more requirements based at least in part on the location information;
modifying, by the computing service, the electronic document based at least in part on the one or more requirements; and
allowing, by the computing service, the user to electronically sign the modified electronic document in accordance with the one or more requirements.

2. The computer-implemented method of claim 1, wherein the user is a sender of the electronic document, wherein the location information is determined by the computing service based at least in part on a geographic location of a computing device operated by the user, and wherein the one or more requirements include jurisdictional requirements associated with the geographic location.

3. The computer-implemented method of claim 1, wherein the user is a signer of the electronic document, wherein the one or more requirements include jurisdictional requirements associated with the location information of the signer, and further comprising generating, by the computing service, the electronic document prior to determining the location information.

4. The computer-implemented method of claim 1, further comprising:
receiving, by the computing service, a pre-authorization describing an allowable modification to the electronic document;
determining, by the computing service, whether the pre-authorization authorizes the electronic document to be modified according to a required modification, the required modification being based at least in part on the one or more requirements;
when the pre-authorization authorizes the electronic document to be modified according to the required modification, automatically modifying, by the computing service, the electronic document based at least in part on the required modification; and
when the pre-authorization prohibits the electronic document from being modified according to the required modification, generating, by the computing service, a notification indicative of the required change.

5. The computer-implemented method of claim 1, further comprising:
determining, by the computing service, second location information;
determining, by the computing service based at least in part on the second location information, one or more second requirements for electronically signing the electronic document;
determining, by the computing service, whether the one or more second requirements conflict with the one or more requirements;
when the one or more second requirements conflict with the one or more requirements, generating, by the computing service, a notification indicative of the conflict; and
when the one or more second requirements are compatible with the one or more requirements, modifying, by the computing service, the electronic document based at least in part on the one or more second requirements.

6. The computer-implemented method of claim 1, further comprising:
determining, by the computing service, a workflow describing a plurality of actions to be performed in conjunction with the electronic signing of the electronic document;
performing, by the computing service, a first action of the workflow prior to allowing the user to electronically sign the modified electronic document; and
performing, by the computing service, a second action of the workflow post allowing the user electronically sign the modified electronic document.

7. The computer-implemented method of claim 6, wherein actions of the workflow are specified by the user.

8. The computer-implemented method of claim 7, wherein an action of the workflow specified by the user is modified by the computing service based at least in part on the one or more requirements.

9. The computer-implemented method of claim 6, wherein actions of the workflow are based at least in part on the one or more requirements.

10. A system comprising:
a processor;
a memory communicatively coupled to the processor and bearing instructions that, upon execution by the processor, cause the system to at least:
determine a workflow for allowing a first user to electronically sign an electronic document;
determine a first location of the first user and a first requirement associated with the first location, the first requirement applicable for electronically signing the electronic document;
modify the workflow or the electronic document to satisfy the first requirement; and
present the electronic document to the first user for electronically signing the electronic document, the presented electronic document satisfying the first requirement based at least in part on the modification to the workflow or to the electronic document.

11. The system of claim 10, wherein the instructions further comprise instructions that, upon execution by the processor, cause the system to:
determine a second location associated with a second user, the second user being requested to electronically sign the electronic document;
determine, based at least in part on the second location, a second requirement for the electronic document to be valid; and
determine whether a conflict exists between the first requirement and the second requirement.

12. The system of claim 11, wherein the instructions further comprise instructions that, upon execution by the processor, cause the system to:
modify, based at least in part on the second requirement, the workflow or the electronic document when the conflict is non-existing; and
notify the first user or the second user when the conflict exists.

13. The system of claim 11, wherein the first user specifies actions of the workflow and content of the electronic document, and wherein the workflow or the electronic document is modified based at least in part on the second requirement.

14. The system of claim 10, wherein the instructions further comprise instructions that, upon execution by the processor, cause the system to:
determine a first authorization from the first user for an allowable modification prior to determining the first requirement, wherein modifying the workflow or the electronic document is automatic if the modification meets the allowable modification, and wherein modifying the workflow or the electronic document further comprises receiving an authorization from the first user prior to the modification when the modification does not meet the allowable modification.

15. A computer-readable storage medium storing instructions that, when executed on a computing device, configure the computing device to perform operations comprising:
provide an interface to a user for electronically signing an electronic document;
determine a location of the user;
determine one or more requirements for electronically signing the electronic document based at least in part on the location of the user;
update the electronic document or a workflow for electronically signing the electronic document to meet the one or more requirements; and
allow, based at least in part on the update, the user to electronically sign the electronic document by way of the interface.

16. The computer-readable storage medium of claim 15, wherein the interface is further configured to allow the user to identify an additional location, and further comprising instructions that, when executed on the computing device, configure the computing device to update the one or more requirements based at least in part on the additional location.

17. The computer-readable storage medium of claim 15, further comprising instructions that, when executed on the computing device, configure the computing device to update the one or more requirements based at least in part on an location associated with an additional user.

18. The computer-readable storage medium of claim 17, wherein the additional location is available prior to updating the one or more requirements.

19. The computer-readable storage medium of claim 17, wherein the location of the user is associated with a first requirement for accepting an electronic signature of the user, and wherein the location of the additional user is associated with a second requirement for accepting an electronic signature of the additional signature, and further comprising instructions that, when executed on the computing device, configure the computing device to: modify the electronic document based at least in part on the first requirement and the second requirement.

20. The computer-readable storage medium of claim 17, further comprising instructions that, when executed on the computing device, configure the computing device to allow, based at least in part on the one or more requirements, the additional user to electronically sign the electronic document by way of the interface.
